(19) United States
(12) Patent Application Publication
(10) Pub. No.: US 2005/0042910 A1
(43) Pub. Date: Feb. 24, 2005

(54) Connector structure

(76) Inventors: Chang Kuo Hua, Shu Lin City (TW); Chain Fu-Ming, Shu Lin City (TW)

Correspondence Address: CHARLES E. BAXLEY, ESQ., 90 JOHN STREET, THIRD FLOOR, NEW YORK, NY, 10038, US

(21) Appl. No.: 10/643,234

(22) Filed: Aug. 18, 2003

(51) Int. Cl. H01R 13/627

(52) U.S. Cl. 439/352

(57) ABSTRACT

A connector structure is easy for assembling and has good resistance to scratch, which has ability of overcoming the disadvantage of conventional connector that is susceptible to scratch. Wherein between a mouth and engaging holes of a female member of the connector is respectively defined with a protrusion being “z,900” shaped in cross section and having a slide track interiorly formed therein, the edges of the protrusions are structured at an optimal angle with corresponding to the round engaging knobs of the male member, by this way, the edge of the protrusions and the engaging knobs of the connector of the present invention may be prevented from being scratched, and the “z,900” shaped structure is conducive to improve the endurance of the female member of the connector.

### BACKGROUND OF THE INVENTION

1. Field of the Invention

The present invention relates to a connector structure, and more particularly to a connector which having a protrusion “z,900” shaped in cross section and defined between mouth and each engaging hole of a female member respectively, the protrusions are capable of facilitating the assembly but also preventing the engaging knobs of the male member from being scratched by the corresponding engaging holes of the female member, moreover, the “z,900” shaped structure is also able to reinforce the endurance of the female member of the connector.

2. Description of the Prior Arts

A conventional connector structure is shown in FIGS. 1-2 and normally including: a male member 10 and a female member 11, both of which are engaged together. Wherein the male member 10 is provided with an inserting portion 101 and serves to insert in a groove 111 of the female member 11. The female member 11 is defined with a pair of engaging holes 112 on the groove 111, on the inserting portion 101 of the male member 10 is correspondingly formed with inserting blocks 102 which having a gradient A. The male member 10 and the female member 11 are engaged together by virtue of engagement of the inserting blocks 102 in the engaging holes 112. Such kind of connector structure has been sold in market and applied by customers for a long period of time, however, there are still some disadvantages of which need to be improved as follows:

First, during assembling, when the inserting blocks 102 of the male member 10 passes an edge of the groove 111 of the female member 11, the gradient A of the inserting blocks 102 would have been scratched, especially the tip of the inserting blocks 102 as well as the edge of the groove 111 are more susceptible to damage. Thereby the connector would have been damaged before leaving the factory and it cannot endure another time of assembling and dismantling again. Furthermore, the damaged inserting blocks 102 will have influence on the tightness of the connector, which possibly results in a disengagement of the male member 10 from the female member 11 as well as future hidden troubles.

Second, since the inserting blocks 102 of the male member 10 and the edge of the groove 111 in female member 11 are susceptible to damage, the conventional connector is not applicable to DIY.

Third, the edge of the groove 111 of the female member 11 is not provided with guiding structure with corresponding to the inserting blocks 102, thus the inserting blocks 102 have difficulties in engaging with the groove of the female member 11. And it will spoil the connector if pushing too hard.

The present invention has arisen to mitigate and/or obviate the afore-described disadvantages of the conventional connector structure.

### SUMMARY OF THE INVENTION

The primary object of the present invention is to provide a connector which has good resistance to scratch, wherein between a mouth and engaging holes of a female member of the connector is respectively defined with a protrusion which having a slide track interiorly formed therein, the edge of the protrusions are structured at an optimal angle with corresponding to the round engaging knobs of the male member, by this way, the edge of the protrusions and the engaging knobs of the connector of the present invention may be prevented from being scratched.

Another object of the present invention is to provide a connector that capable of facilitating the assembly, by virtue of the slide track formed in the protrusions which enables quick engagement with the engaging knobs, whereby to facilitate the assembly.

The further object of the present invention is to provide a connector structure that has strong structural strength, wherein the “z,900” shaped structure is conducive to improve the endurance of the edge of the protrusion (the base body of the female member of the connector can be reinforced in endurance too)

The present invention will become more obvious from the following description when taken in connection with the accompanying drawings, which shows, for purpose of illustrations only, the preferred embodiments in accordance with the present invention.

### BRIEF DESCRIPTION OF THE DRAWINGS

FIG. 1 is a side exploded view of a conventional connector;

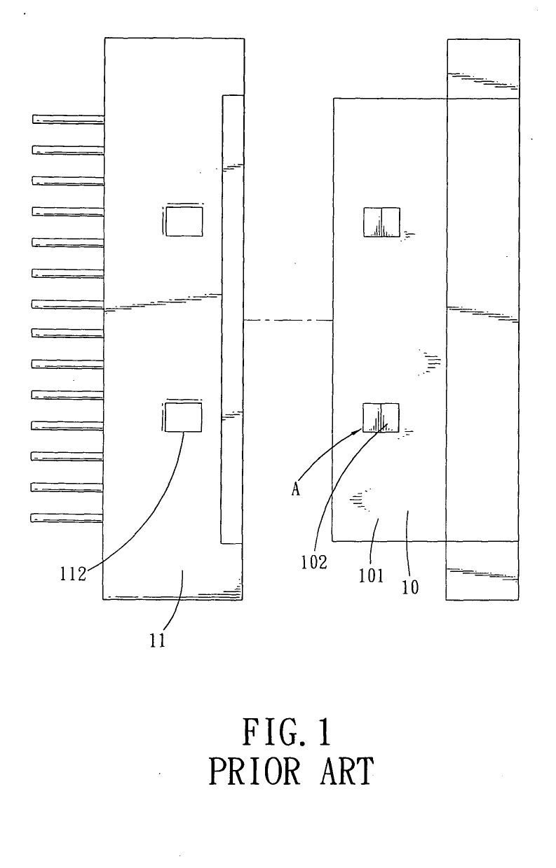

FIG. 2 is a cross sectional assembly view of the conventional connector;

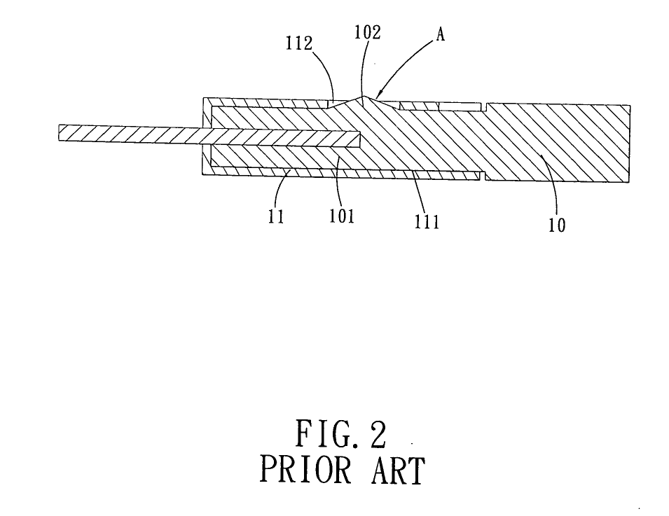

FIG. 3 is an exploded view of a connector of the present invention;

FIG. 4 is a cross section assembly view of the connector of the present invention;

FIG. 5 is a partial cross sectional view of the connector of the present invention;

FIG. 6 is another partial cross sectional view of the connector of the present invention;

FIG. 7 is an exploded view of a connector in accordance with another embodiment of the present invention.

### DETAILED DESCRIPTION OF THE PREFERRED EMBODIMENTS

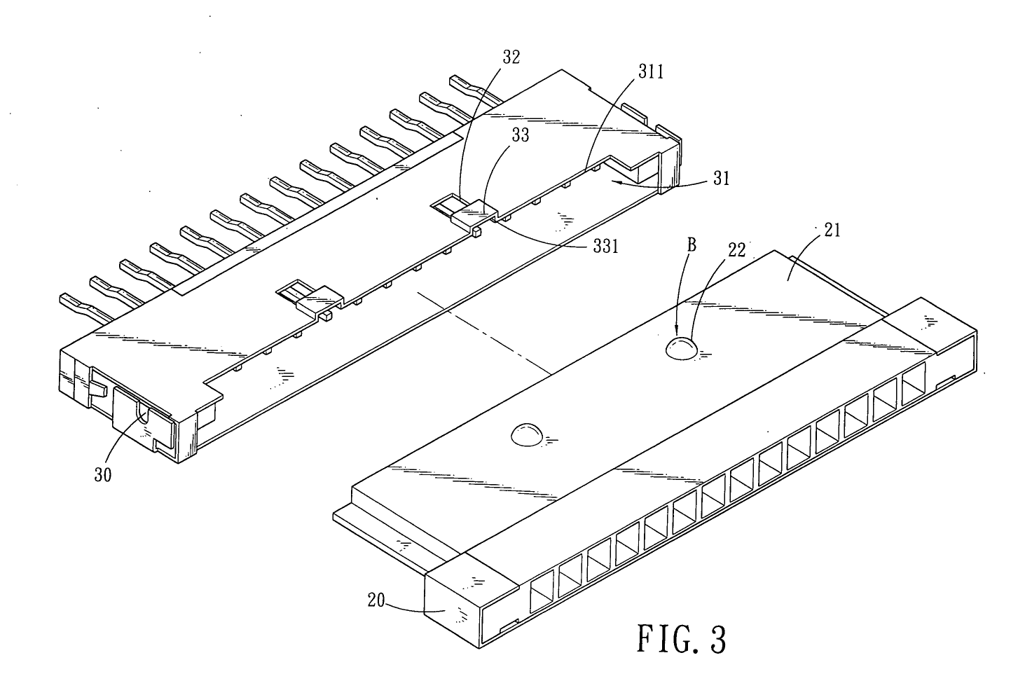

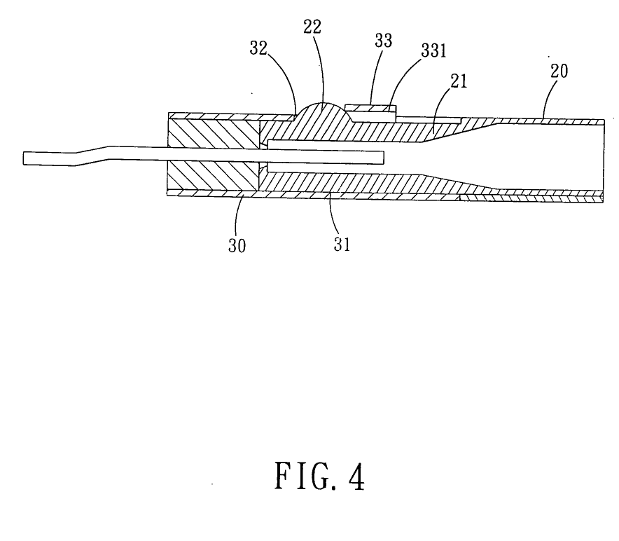

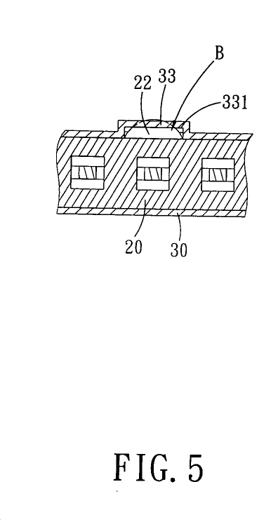

Referring to FIGS. 3-5, a connector of the present invention generally comprises a male member 20 and female member 30.

The male member 20 is a carrier for electronic circuit and provided with an inserting portion 21, on the inserting portion 21 defined a pair of semi-spherical engaging knobs 22 are defined.

The female member 30 is a carrier for electronic circuit too and provided with a groove 31, the groove 31 has a mouth 311 for insertion of the inserting portion 21 of the male member 20. On the internal surface of the groove 31 a pair of engaging holes 32 are defined with corresponding to the paired engaging knobs 22 of the male member 20. Between the mouth 311 of the female member 30 and the engaging holes 32 is defined with a protrusion 33 respectively which is “z,900”shaped in cross section and interiorly formed with a slide track 331. Furthermore, a predetermined position of the internal top surface of each protrusion 33 is semi-spherical formed with corresponding to the engaging knobs 22, such that the semi-spheres of the predetermined position will snuggly abut against the curved surface B.

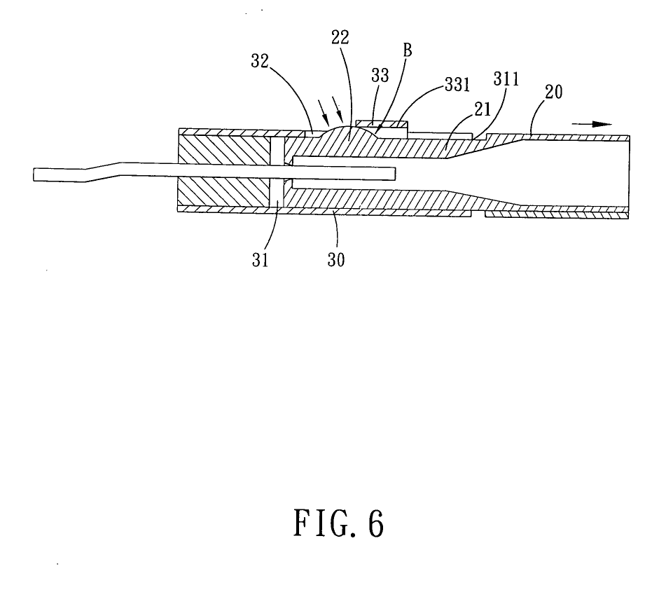

Referring to FIG. 6, which shows that when the user wants to assemble the connector of the present invention, he/she can inserts the inserting portion 21 of the male member 20 in the groove 31 of the female member 30 via the mouth 311. And alike, the two engaging knobs 22 on the inserting portion 21 of the male member 20 are able to enter the mouth 311 through the slide track 331 of the protrusions 33 respectively. Since the edge of the protrusions 33 is structured with corresponding to the curved surface of the engaging knobs 22 of the male member 20, the semi-spherical surface of the engaging knobs 22 is able to avoid the edges of the protrusions 33 successfully, such that the two engaging knobs 22 can enter the slide track 331 accurately and quickly and then engaged in the corresponding engaging holes 32 of female member 30 respectively. It is learned from above description that with the cooperation of the curved surface B, the slide tracks 331 and the edge structure of the protrusions 33, the respective engaging knobs 22 are able to dodge the edges of the protrusions 33 without difficulties and then slide in the slide tracks 331 respectively, so as to avoid scratched damage effectively. In like manner, the engaging knobs 22 also can be disengaged from the corresponding engaging holes 32 of the female member 30 without being scratched by the edges of the respective protrusions 33 with the help of the curved surface B, the slide tracks 331 and the edge structure of the protrusions 33. By this way, the engaging knobs of the male member 20 of connector of the present invention can be prevented from being scratched by the edges of the engaging holes of the female member.

It will be noted that the cross section of the protrusions 33 of the female member 30 is “z,900” shaped (also can be in the shape of “z,900”), the “z,900”-shaped structure plays a role of as a reinforced rib does, so as to increase the endurance of the edge of the respective protrusions 33 (the base body of the female member 30 of the connector can be reinforced in endurance too) as well as preventing the deformation of the same.

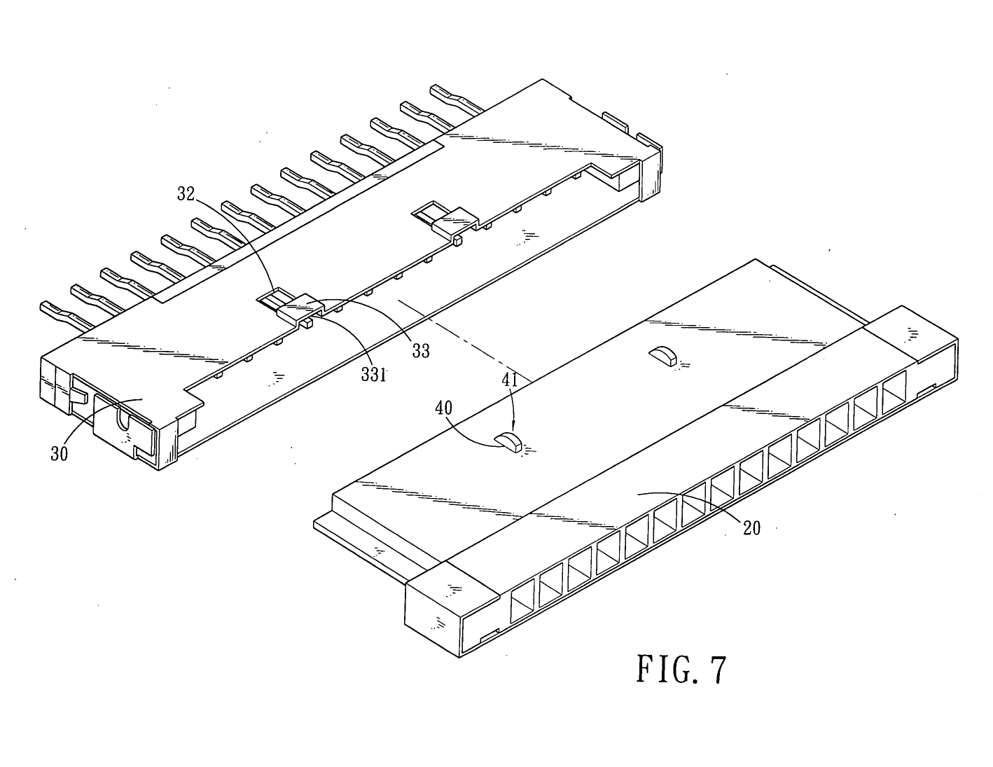

Referring to FIG. 7, which shows that the engaging knobs 22 of the male member 20 in accordance with the present invention also can be in the shape of blocks 40 provided with a curved contacting surface 41 at the top end. When the curved contacting surface 41 of the respective blocks 40 is pushed both by the slide tracks 331 of the female member 30 and the edge structure of the protrusions 33, the blocks 40 may slide into the corresponding slide tracks 331 smoothly while dodging the edge of the protrusions 33 and then engaged in the corresponding engaging holes 32 of the female member 30. Vice versa, if the user pushes the blocks 40 slightly, which will be disengaged from the engaging holes 32 without being scratched by the edge of the protrusions 33.

While we have shown and described various embodiments in accordance with the present invention, it should be clear to those skilled in the art that further embodiments may be made without departing from the scope of the present invention.

1. A connector structure comprising a male member and a female member, the male member having an inserting portion and a plurality of engaging knobs, the female member defined with a groove and a plurality of engaging holes with corresponding to the inserting portion and the engaging knobs of the male member respectively; wherein:
between each mouth and engaging hole of the female member respectively provided with a protrusion and each of which interiorly defined with a slide track, edges of the protrusions being corresponding to a predetermined position of the respective engaging knobs of the male member, the slide track of the protrusions capable of guiding the corresponding engaging knobs during assembling, and the protrusions capable of preventing the corresponding engaging knobs from being scratched by the edges of the respective engaging holes of the female member.

2. The connector structure as claimed in claim 1, wherein the engaging knobs on the male member are semi-spherical formed.

3. The connector structure as claimed in claim 1, wherein the engaging knobs on the male member are blocks having a curved contacting surface defined at the top.

4. The connector structure as claimed in claim 1, wherein the protrusions on the female member are “z,900”-shaped in cross section.

5. The connector structure as claimed in claim 1, wherein the protrusions on the female member are “z,900” shaped in cross section.
